(19) United States
(12) Patent Application Publication
(10) Pub. No.: US 2023/0406437 A1
(43) Pub. Date: Dec. 21, 2023

(54) Steering System for Bicycle Handlebars

(71) Applicant: Canyon Bicycles GmbH, Koblenz (DE)

(72) Inventor: Johannes Thumm, Lörrach (DE)

(21) Appl. No.: 18/206,803

(22) Filed: Jun. 7, 2023

(30) Foreign Application Priority Data
Jun. 8, 2022 (DE) 20 2022 103 224.6

(51) Int. Cl. B62K 3/02

(52) U.S. Cl. CPC B62K 3/02; B62K 2201/00

(57) ABSTRACT

A steering system for bicycle handlebars comprises a holding element fixed to the steer tube, in particular above an upper bearing element. A fixing element is arranged between two bearing elements. The fixing element is not directly connected to the steer tube, but is connected, in particular by form-fit, to the holding element by means of a connection means.

### CROSS-REFERENCE TO RELATED APPLICATION

This application claims priority to German Patent Application No. 20 2022 103 224.6 filed Jun. 8, 2022, the disclosure of which is hereby incorporated by reference in its entirety.

### BACKGROUND OF THE INVENTION

### Field of the Invention

The invention relates to a steering system for bicycle handlebars.

### Description of Related Art

Steering systems for bicycle handlebars typically comprise two bearing elements arranged in a head tube of a bicycle frame, said bearings typically being ball bearings. These serve for a pivotable bearing of a steer tube of a bicycle fork. Here, the steer tube is typically connected to two fork legs via a fork bridge. A connection with a handlebar stem is made at an upper free end of the steer tube.

For example, a steering stop may be connected to the steer tube. For example, a steering stop is known from DE 20 2012 008 119.5, which comprises a first stop element adapted to be clamped to the steer tube of a bicycle fork. A second stop element, which serves to limit a steering lock, cooperates with the first stop element. The second stop element is attached to an upper side of the top tube by two screws.

### SUMMARY OF THE INVENTION

It is an object of the invention to provide a steering system for bicycle handlebars that has additional functions.

The object is achieved, according to the invention, with a steering system having the features as described herein.

The steering system for bicycles according to the invention comprises a steer tube pivotably supported in a head tube of a bicycle frame via two bearing elements which, in particular, are ball bearings. A holding element is connected to the steer tube. The holding element which may in particular be of annular design and preferably surrounds the steer tube completely, is fixed at the steer tube above the upper bearing element. Thus, the holding element is arranged in particular between the upper bearing element and the handlebar stem. Preferably, a clamping fixation may be made by providing a clamping element, where it is particularly preferred that the holding element is of annular design and comprises a slot, so that a clamping fixation of the holding element to the steer tube can be made in a simple manner using a clamping screw or the like.

The steering system according to the invention further comprises a fixing element. The fixing element is arranged between the two bearing elements. The fixing element is thus arranged inside the head tube and is protected, in particular, against dirt by the head tube. The fixing element serves, for example, for connection to a steering stabilization means. The steering stabilization means serves in particular to stabilize straight-ahead traveling. Preferably, a spring element is provided as a steering stabilization means, so that the steering stabilization means comprises at least one spring element. The spring element, which may be am elastic element, a stretchable band, a spring or the like, generates a restoring force. This restoring force is generated by the steering movement, so that a restoring moment is generated. It is preferred that the steering stabilization means is arranged at least in part in the top tube of the bicycle frame. It is particularly preferred that the steering stabilization means is not visible from outside and, as such, is arranged entirely inside the top tube and in the head tube of the frame. For example, two stabilization elements of band-like design may be fastened opposite each other to the fixing element. The two band-shaped stabilization elements are preferably guided towards the top tube and are themselves elastic and/or connected to an elastic element. The steering stabilization means may also be designed as a torsion spring or comprise a torsion spring. The fixing element may also be connected to another element or be designed as such element. For example, it may be a steering stop which, in this case, is arranged between the two bearing elements.

Irrespective of the exact design and function of the fixing element and of the holding element, the essential element of the invention consists in the fixing element being connected to the holding element via a connection means. As such, according to the invention, the holding element which is arranged above the upper bearing element and is, in particular, well accessible and may be connected to the steer tube in a simple manner, e.g. by clamping, can be connected to a fixing element arranged in the head tube. Thus, the fixing element does not have to be fixedly clamped to the steer tube or be connected thereto in another manner. It is preferred that the connection means realizes a rotatory connection between the holding element and the fixing element. In a particularly preferred embodiment, the rotatory connection is implemented by a form fit. According to the invention, it is thus not necessary to fixedly connect the fixing element arranged in the head tube to the steer tube. In particular a rotatory connection for force transmission in the direction of rotation is not necessary. In this respect, for example, neither an opening in the frame, in particular in the head tube, is necessary, through which the fixing element would have to be accessible for connection to the steer tube.

The connection means preferably comprises a connection ring which surrounds the steer tube and has protrusions and/or recesses for a form-fitting rotatory connection which cooperate with protrusions and/or recesses of the fixing element. The connection ring may be a separate element. However, the connection ring may also be the holding element. The connection ring preferably is an independent element, since this facilitates assembly. In this preferred embodiment, the connection ring is connected to the holding element in particular in a form-fitting manner. The connection ring preferably comprises protrusions and/or recesses that cooperate with protrusions and/or recesses provided in the holding element, so as to reliably transmit rotational forces.

The connection ring is preferably designed such that it is at least of a partially annular design, in particular of a fully annular design. The connection ring has an outer surface on which, in a preferred embodiment, the upper bearing element abuts. In particular, an inner ring of an upper bearing element is in contact with the outer surface. Thus, the connection ring is preferably arranged within the bearing element and, in a particularly preferred embodiment, supports the inner ring of the bearing element. The connection ring comprises corresponding recesses and/or protrusions which possibly interrupt the annular element or the annular contact surface.

The fixing element is preferably also fixed against slipping in the longitudinal direction of the steer tube. This may be achieved, for example, by the steer tube having a conical portion widening in the direction of the lower bearing element. Thereby, the axial position of the fixing element or the position of the fixing element in the longitudinal direction of the steer tube is defined. A longitudinal holding element, e.g. a sleeve, protrusions connected to the head tube and/or the steer tube, or the like may also be provided on the steer tube. Furthermore, the connection between the fixing element and the connection means, in particular the connection ring, may be such that a locking connection is made so as to avoid axial displacement of the fixing element inside the head tube.

In a development of the invention, a recess for passing lines therethrough may be provided in the holding element and/or the connection means, in particular the connection ring. The lines are cables, Bowden cables and the like Using the steering stop according to the invention, it is thus possible to insert lines into the interior of the steer tube or to insert them laterally beside the steer tube into the head tube of the bicycle frame and then to guide them through the bicycle frame, for example to an electrical or mechanical gearshift.

In a particularly preferred development, a steering stop is provided in addition. To this end, preferably the holding element is designed as a first stop element and/or connected to a first stop element. The first stop element comprises two stops and cooperates with a second stop element arranged, for example, on or in the top tube.

Preferably, the first stop element is designed to be annular in shape and preferably surrounds the steer tube completely. It is particularly preferred that the in particular annular first stop element can be fixed to the steer tube by means of a clamping element. In a particularly preferred embodiment this is realized by the first stop element being annular in shape and having a slot. Using a clamping element, in particular in the form of a screw, a clamped fixing of the first stop element to the steer tube can be realized in a simple manner. It is particularly preferred that the holding element is designed as the first stop element.

It is particularly preferred that the two stops of the first stop element comprise stop surfaces. In the event of an extreme right or left steering lock of the handlebar, these surfaces come into contact with the second stop element at the respective limit angles. The two stop surfaces preferably have an angle of less than 300° with respect to each other. Specifically, the angle is smaller than 250° and, as is particularly preferred, smaller than 180°. Due to the second stop element, which also has a certain width, the maximum possible steering angle is reduced by 10° to 20°, for example. Thus, the handlebar can be turned by 70° to 100° with respect to the traveling direction, before the left or right stop surface comes to contact second stop element.

Furthermore, it is preferred that the first stop element serves as a cover element, in particular a cover ring, in particular for the upper headset bearing. The in particular annular first stop element thus comprises an additional protective function, in particular against contamination, for the upper headset bearing. It is preferred that the at least one recess for the passage of lines is provided on a side of the stop surface opposite or directed away from the stop surface. When providing two stop surfaces and at least two recesses, it is preferred that at least one of the recesses per stop is arranged on the side directed away from or opposite to the stop surface, respectively. This is the side that faces in the traveling direction in the mounted state. The at least one recess is preferably configured such that it is open to the outside. In a preferred embodiment, this is not a passage opening, but a recess or an indentation. Here, it is relevant that the at least one recess is configured such in the mounted state of the first stop element that lines can be inserted into the head tube of the bicycle frame through the recess. Thus, it is possible in a simple manner to insert, for example, lines from a brake and/or shift lever unit laterally on the first stop element in the region of the recess into the frame, in particular the head tube of the frame.

The second stop element can be fixed directly or indirectly to the bicycle frame. Preferably, a fixing is made in the area of the top tube of the bicycle frame. Here, it is possible to arrange the second stop element on an upper side of the top tube. However, since this causes dirt deposits in this area and may possibly also cause injuries, it is preferred in a particularly preferred embodiment, to arrange the second stop element in the bicycle frame, in particular the top tube of the bicycle frame. The second stop element is thus essentially invisible from outside. In the mounted state, it is preferred in this respect that the second stop element is arranged below an upper side of the top tube. Correspondingly, also the arrangement of the first stop element is preferably such that it is arranged below the upper side of the top tube. Providing the second stop element in, in particular inside, the bicycle frame, in particular the top tube, is an invention independent of the provision of at least one recess for passing lines therethrough, with the combination of both inventions, however, representing an advantageous development.

Preferably, the top tube has a recess in which the second stop element is arranged. In particular, the second stop element can be inserted into this recess. The fixing can be effected using corresponding fixing means, locking elements or also in a clamping manner, in particular solely due to form fit. The recess, in which the second stop element is arranged, is preferably open in the direction of the steer tube of the frame.

It is particularly preferred that the second stop element comprises a retaining element which serves for connection to the bicycle frame, in particular for insertion into the recess. Furthermore, in a preferred development, the second stop element comprises a stop. The stop is preferably connected to the retaining element via a connecting web. Here, it is particularly preferred that this connecting web is formed as a rated breaking point. This has the advantage that, when large forces occur, damage to the bicycle frame in the area of the arrangement of the retaining element is avoided, since the stop breaks off from the retaining element. This absorbs a large amount of energy, so that the risk of damage to the top tube by components fastened to the handlebar is further reduced.

In a further preferred embodiment of the invention, an in particular annular cover element is provided on an upper side of the first stop element. It is particularly preferred to cover the recesses using this cover element in order to prevent the intrusion of water and dirt. Therefore, it is preferred that the cover element has a passage opening through which the lines can be passed towards the at least one recess in the first stop element. Preferably, the at least one passage opening of the cover element is closed by a closure element. The same preferably surrounds the lines guided therethrough in a substantially sealing manner. It is particularly preferred that the closure element is made of an elastic plastic material such as a rubber and comprises at least one slot for passing lines therethrough. In particular, a cross-shaped slot is provided.

Since it is particularly preferred that the first stop element or the holding element is clampingly connected with the steer tube, it is possible to maintain a pretension to be applied to the headset bearings. Thus, for assembly, the two headset bearings are first pretensioned against each other and the first stop element is then fixed to the steer tube in a clamping manner. This has the advantage that, for example for transport purposes, the stem can be detached from the steer tube together with the handlebar without the need to adjust the pretension of the headset bearings during reassembly.

### BRIEF DESCRIPTION OF THE DRAWINGS

In the following, the invention is described in more detail by means of a preferred embodiment with reference to the accompanying drawings.

In the drawings:

FIG. 1 shows a schematic perspective view of the two stop elements,

FIG. 2 shows a schematic perspective top plan view on the cover element,

FIG. 3 shows a partly sectional view of the entire steering stop in the mounted state, and

FIG. 4 shows a perspective, partly sectional view of a steering system in combination with the steering stop shown in FIGS. 1 to 3.

### DESCRIPTION OF THE INVENTION

The steering stop comprises a first stop element 10, as well as a second stop element 12 cooperating therewith. The first stop element 10, which in particular is designed to be annular in shape, comprises two mutually opposite stop elements 14, 16. Each stop element 14, 16 has a stop surface 20, 22 on the rear side facing in the direction opposite to the direction of travel 18. When the handlebar is turned left in the traveling direction, the steering angle is limited by the fact that the stop surface 20 abuts against a stop surface 24 of the second stop element 12, which is the left stop surface in the traveling direction. Analogously, the stop surface 22 of the stop 16 abuts against the right stop surface 26 in the case of an extreme right steering angle.

In the preferred embodiment illustrated, the first stop element 10 is clampingly fixed to a steer tube not illustrated. To this end, the first stop element has a slot 28, the slot width and thus the inner diameter of the first stop element being adapted to be reduced using a clamping element such as a clamping screw 30.

In the embodiment illustrated, the first stop element comprises two recesses 32, 34. These recesses are arranged on the opposite side of the stop surfaces 20, 22 of the stops 14, 16, respectively. In other words, the two recesses 32, 34 are arranged in front of the stops 14, 16 with respect to the traveling direction 18. As such, it is possible to insert lines into the frame in this area, in particular into the head tube of the frame.

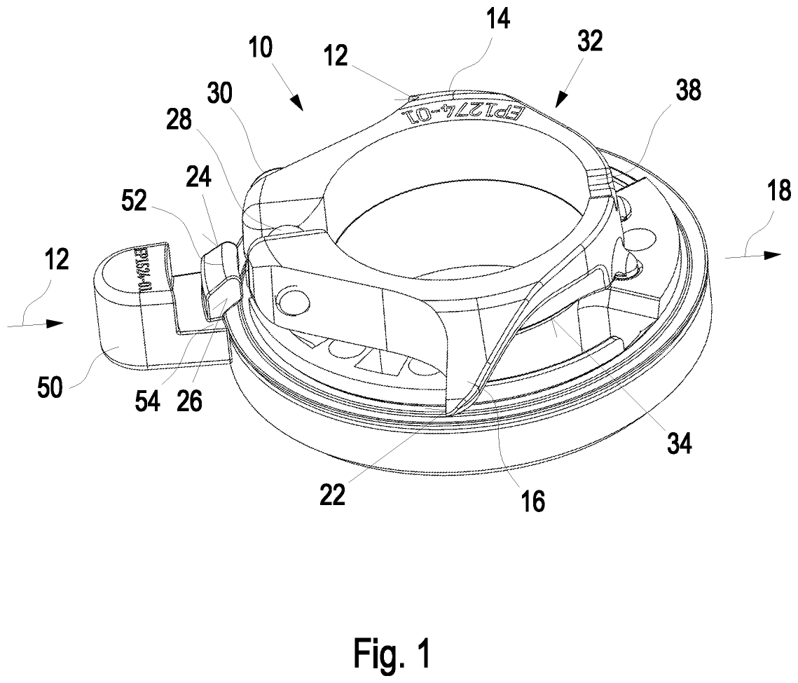

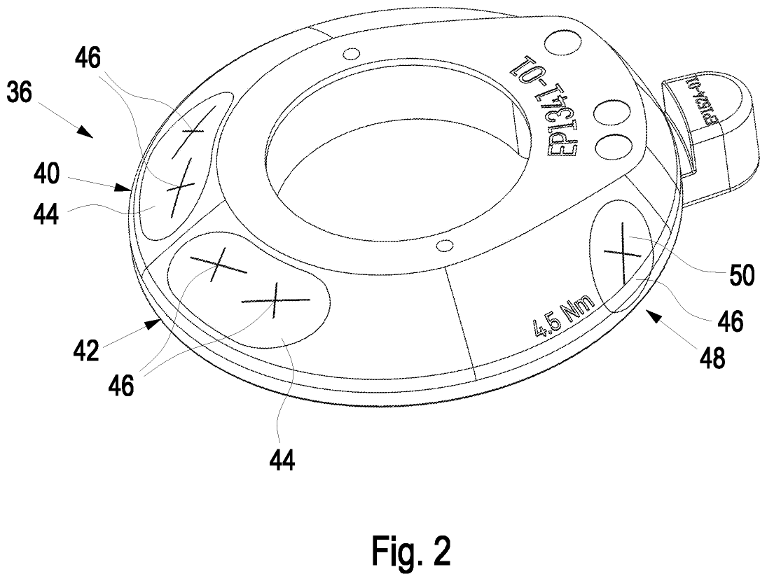

For covering, the first stop element 10 is a cover element 36 (FIG. 2) which is preferably also formed to be annular in shape. The cover element 36 has a nose directed downward and not visible in the Figure, which nose engages in a recess 38 (FIG. 1) of the first stop element, so that a twisting of the cover element 16 is prevented.

The cover element has passage openings 40, 42 in the area of the recesses 32, 34. Both passage openings are closed by a closure element 44, respectively, each closure element 44 comprising two cross-shaped slots for passing lines, cables, and the like therethrough, so that these can be passed through in a sealed manner.

In the mounted state, the passage opening 42 is arranged above the recess 32 and the passage opening 44 is arranged above the recess 34.

Furthermore, the cover element 36 has a passage opening 48 which is also closed by a closure element 50 with slots 46. The passage opening 46 serves for passing a tool therethrough and, in the mounted state, is arranged at the level of the screw 30.

In operation, the steering force of the first stop element 10 on the steer tube is set such that, when one of the two stops 14, 16 strikes, initially the first stop element twists on the steer tube. The first stop element can be turned back and be clamped again in a simple manner by loosening the screw 30.

The second stop element comprises a retaining element 50, as well as a stop 52. The stop 52 forms the opposing stop surfaces 24, 26. The stop 52 is connected to the retaining element 50 via a connecting web 54. Here, the connecting web 54 serves as a rated breaking point. If, for example, the first stop element is not twisted on the steer tube because of excessive clamping forces or, for example, because of contamination, the connecting web will break, so as to prevent excessive force from being introduced into the bicycle frame via the retaining element 50.

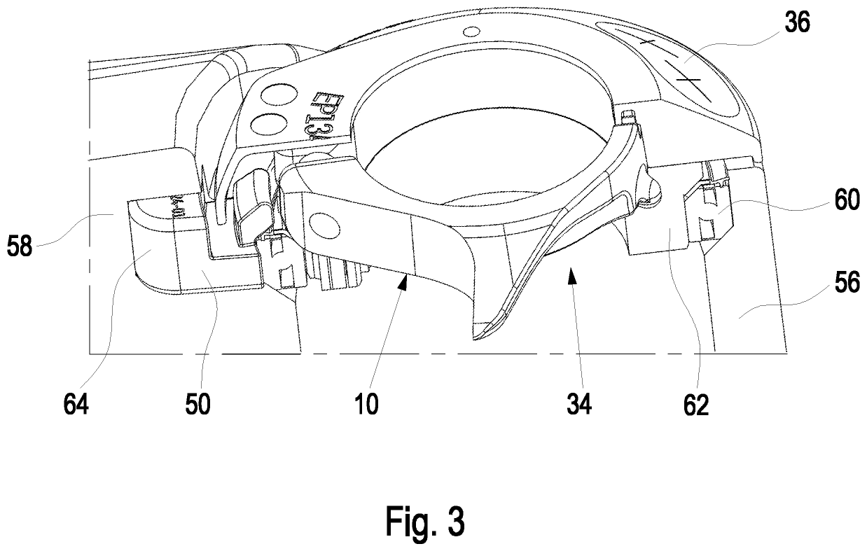

In the mounted state (FIG. 3), a head stube 56 of the bicycle frame is connected to or formed integrally with a top tube 58. The steer tube of the bicycle fork is arranged in the head tube 56 and is rotatably supported by an upper headset bearing 60 and a lower headset bearing which is not illustrated. In the embodiment illustrated, a respective compression ring 62 is provided for fixing the headset bearings 60. The same preferably also has line passages, provided that the compression ring 62 is also arranged in the area of the recesses 32, 34. After the pretensioning of the two headset bearings 60, the first stop element 10 is clampingly fixed, so that the pretension of the headset bearings is maintained, regardless of whether the stem is mounted or dismounted.

The retaining element 50 of the second stop element 12 is inserted into a recess 64, which is provided on a side of the top tube 58 facing in the direction of the head tube 56. In the embodiment illustrated, fixing is effected by the upper headset bearing 60. Since the retaining element 50 is arranged in the recess 54 provided in the top tube 58, the same is not visible.

Then, the cover element 36 (FIG. 2), which is illustrated only schematically in FIG. 3, is arranged above the first stop element 10.

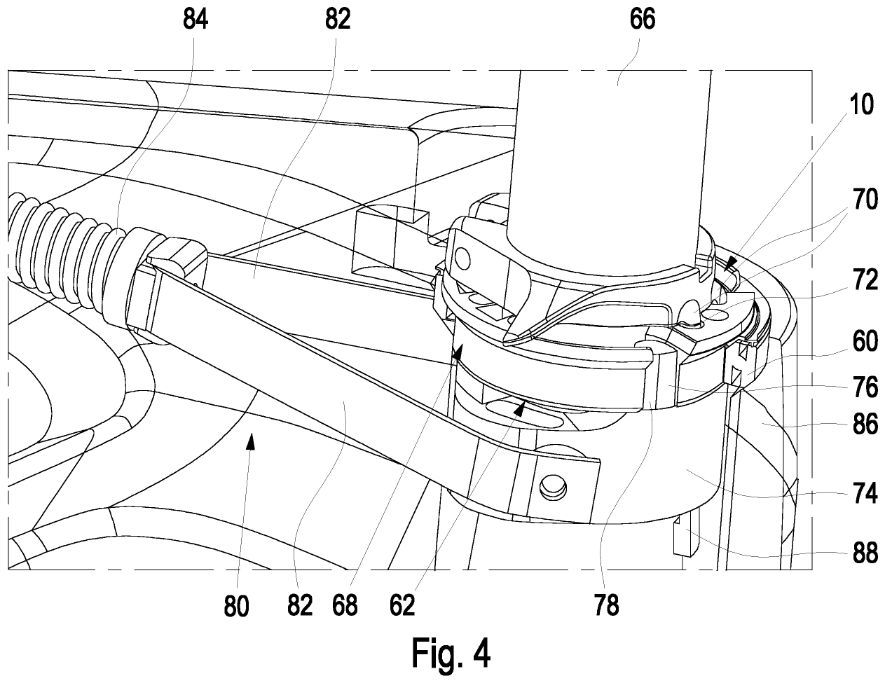

The steering system illustrated in FIG. 4 is a particularly preferred embodiment, in which the first stop element 10 illustrated in FIGS. 1 to 3 is arranged above the upper headset bearing 60. Instead of the first stop element 10, a holding element may be provided that is arranged on the steer tube 66 in particular in a clamping manner. This may be a clamping ring which, different from the first stop element 10, possibly has no additional function. Below the first stop element 10, the compression ring 62 is provided as the connection element. The same also surrounds the steer tube 66 and supports the inner ring of the bearing 60 on an outer side 68.

For a form-fitting connection and for a transmission of torques, the first stop element 10 comprises protrusions 70 engaging into corresponding recesses 72 in the compression ring 62.

A fixing element 74 is provided below the connection or compression ring 62. The same is substantially annular in shape and comprises in particular an annular opening in which the steer tube 66 is arranged. A small distance can be provided between the fixing element 74 and the steer tube 66, in particular, no connection is provided that serves for force transmission. For force transmission, the fixing element 74 has protrusions 76 which engage into recesses 78 in the compression ring 62. Thus, the fixing element can transmit forces and, accordingly, also moments to the connection ring 62 via protrusions 76. The corresponding forces can be transmitted from the connection ring 62 to the first stop element 10 or a holding element via the protrusions 70. Due to the stop element 10 being fixed th teh steer tube in a clamping manner, a corresponding force transmission to the steer tube 66 is effected.

In the embodiment illustrated, a steering stabilization means 80 is connected to the fixing element 74. In the embodiment illustrated, the steering stabilization means 80 comprises two band-shaped stabilization elements 82 connected to the fixing element 74 on opposite sides. The two band-shaped stabilization elements 82 may be elastic and/or be connected either indirectly or directly to the bicycle frame via a spring element 84. By turning the handlebar and, thus, by turning the steer tube 66, one of the two bands 82 is stretched and/or the spring 84 is extended. This results in a restoring moment, so that forces are transmitted from the fixing element 74 to the first stop element 10 via the protrusions 76, 70 and, thus, to the steer tube 66 again. Thereby, the handlebar is rotated back to its neutral position.

The fixing element 74 is arranged within a head tube 86 of the bicycle frame, as well as between the upper bearing 60 and the lower bearing not illustrated. In order to avoid a slipping of the fixing element 74 in the axial direction, i.e., for example, downward in FIG. 4, a longitudinal holding element 88 is provided in the embodiment illustrated, which, in particular, is a sleeve. The same can be fixed on the steer tube 66 in a simple manner, if the steer tube is shaped conically below the fixing element 74 and widens in the direction of the lower bearing.

Further aspects of the invention:

1. A steering system for bicycle handlebars comprising
a steer tube (66) pivotably supported in a head tube (86) of a bicycle frame via two bearing elements (60),
a holding element (10) fixed on the steer tube (66) in particular above the upper bearing element (60),
a fixing element (74) arranged between the two bearing elements (60), and
a connection means (62) connecting the fixing element (74) to the holding element (10).

2. The steering system for bicycle handlebars according to aspect 1, characterized in that the holding element (10) is fixed to the steer tube (66) in a clamping manner.

3. The steering system for bicycle handlebars according to aspect 1 or 2, characterized in that the connection means is designed as a rotatory connection for transmitting moments, the connection being implemented in particular by form-fit.

4. The steering system for bicycle handlebars according to one of aspects 1 to 3, characterized in that the connection means comprises a connection ring (62) surrounding the steer tube (66) and comprising protrusions and/or recesses (78) for a form-fitting rotatory connection, which cooperate with recesses and/or protrusions (76) of the fixing element (74).

5. The steering system for bicycle handlebars according to aspect 4, characterized in that the connection ring (62) is connected to the holding element (10) in particular in a form-fitting manner, in particular via protrusions and recesses (72) provided in the connection ring, which cooperate with recesses and/or protrusions (70) provided in the holding element (10).

6. The steering system for bicycle handlebars according to one of aspects 4 to characterized in that the connection ring (62) has an at least partly annular outer surface (68) on which the upper bearing element (60) abuts.

7. The steering system for bicycle handlebars according to one of aspects 1 to 6, characterized by a longitudinal holding element (88) for holding the fixing element (74) in the axial direction of the steer tube (66).

8. The steering system for bicycle handlebars according to one of aspects 1 to 7, characterized in that the holding element (10) and/or the connection ring (62) comprise a recess (32, 34) for passing lines therethrough.

9. The steering system for bicycle handlebars according to one of aspects 1 to 8, characterized in that the holding element is designed as a first stop element (10) and/or is connected to a first stop element (10), the first stop element (10) comprising two stops (14, 16) and cooperating with a second stop element (12).

10. The steering system according to one of aspects 8 to 9, characterized in that the second stop element (12) is adapted to be arranged in a recess (64) in the bicycle frame, in particular in the top tube (34) of the bicycle frame.

11. The steering system for bicycle handlebars according to any one of aspects 7 to 10, characterized in that the second stop element (12) comprises a retaining element adapted, in particular, for insertion into the recess (64), and a stop (52) connected to the retaining element (50).

1. A steering system for bicycle handlebars comprising
a steer tube pivotably supported in a head tube of a bicycle frame via two bearing elements,
a holding element fixed on the steer tube in particular above the upper bearing element,
a fixing element arranged between the two bearing elements, preferably for connecting to a steering stabilization means, and
a connection means connecting the fixing element to the holding element.

2. The steering system for bicycle handlebars according to claim 1, wherein the holding element is fixed to the steer tube in a clamping manner.

3. The steering system for bicycle handlebars according to claim 1, wherein the connection means is designed as a rotatory connection for transmitting moments, the connection being implemented in particular by form-fit.

4. The steering system for bicycle handlebars according to claim 1, wherein the connection means comprises a connection ring surrounding the steer tube and comprising protrusions and/or recesses for a form-fitting rotatory connection, which cooperate with recesses and/or protrusions of the fixing element.

5. The steering system for bicycle handlebars according to claim 4, wherein the connection ring is connected to the holding element in particular in a form-fitting manner, in particular via protrusions and recesses provided in the connection ring, which cooperate with recesses and/or protrusions provided in the holding element.

6. The steering system for bicycle handlebars according to claim 4, wherein the connection ring has an at least partly annular outer surface on which the upper bearing element abuts.

7. The steering system for bicycle handlebars according to claim 1, wherein a longitudinal holding element for holding the fixing element in the axial direction of the steer tube.

8. The steering system for bicycle handlebars according to claim 1, wherein the steering stabilization means comprises a spring element.

9. The steering system for bicycle handlebars according to claim 1, wherein the steering stabilization means is at least partly arranged in the top tube of the bicycle frame.

10. The steering system according to claim 1, wherein the steering stabilization means comprises two in particular band-shaped stabilization elements which are connected to the fixing element preferably opposite each other.

11. The steering system for bicycle handlebars according to claim 1, wherein the holding element and/or the connection ring comprise a recess for passing lines therethrough.

12. The steering system for bicycle handlebars according to claim 1, wherein the holding element is designed as a first stop element and/or is connected to a first stop element, the first stop element comprising two stops and cooperating with a second stop element.

13. The steering system according to claim 1, wherein the second stop element is adapted to be arranged in a recess in the bicycle frame, in particular in the top tube of the bicycle frame.

14. The steering system for bicycle handlebars according to claim 1, wherein the second stop element comprises a retaining element adapted, in particular, for insertion into the recess, and a stop connected to the retaining element.
